(19) United States
(12) Patent Application Publication
(10) Pub. No.: US 2008/0249250 A1
(43) Pub. Date: Oct. 9, 2008

(54) Copolymers Containing Lateral Carbamate Groups And Groups Which Can Be Activated With Actinic Radiation, Processes For Preparing Them, And Their Use

(75) Inventors: Heinz-Peter Rink, Munster (DE); Wilma Nimz, Haltern am See (DE); Ulrike Rockrath, Seden (DE); Eva Wagner, Speyer (DE); Swaminathan Ramesh, Canton, MI (US); Paul J. Harris, West Bloomfield, MI (US)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 11/995,839

(22) PCT Filed: Jul. 18, 2006
(86) PCT No.: PCT/EP2006/007058

§ 371 Date: Jan. 16, 2008

(30) Foreign Application Priority Data
Jul. 19, 2005 (DE) 10 2005 033622.1

(51) Int. Cl. C08G 69/08; C08G 12/00; C08G 18/00; C08F 226/00

(52) U.S. Cl. 525/242; 528/310; 528/228; 528/246; 528/75; 526/301

(57) ABSTRACT

Copolymers (A) containing lateral, primary and/or secondary carbamate groups (a12) and groups (a31) which can be activated with actinic radiation, preparable by

I. in a first process step copolymerizing
(a1) a monomer containing
   (a11) a group of the general formula I:

CH₂═C(R)C(O)—O—, (I)
in which the variable R is a hydrogen atom, a halogen atom, a nitrile group or an alkyl group having 1 to 10 carbon atoms, and
(a12) a primary and/or secondary carbamate group,
and
(a2) a monomer containing
   (a21) a free-radically or ironically polymerizable, olefinically unsaturated double bond and
   (a22) a reactive functional group which is not reactive with the carbamate groups (a12) and is not polymerizable with the double bond (a21),
to give the copolymer (a1/a2), and

II. in a further process step, reacting the copolymer (a1/a2) with
(a3) a compound containing
   (a31) a group which can be activated with actinic radiation and
   (a32) a reactive functional group complementary to the reactive functional group (a22),
to give the copolymer (A);
processes for preparing them, and their use.

### FIELD OF THE INVENTION

The present invention relates to new copolymers containing lateral carbamate groups and groups which can be activated with actinic radiation. The present invention also relates to a new process for preparing copolymers which contain lateral carbamate groups and groups which can be activated with actinic radiation. The present invention further relates to the use of the new copolymers containing lateral carbamate groups and groups which can be activated with actinic radiation, and of the copolymers which contain lateral carbamate groups and groups which can be activated with actinic radiation, prepared by means of the new process, as new materials curable thermally and with actinic radiation, and for their preparation. The present invention relates not least to the use of the new materials curable thermally and with actinic radiation for producing new thermoset materials cured thermally and with actinic radiation.

### PRIOR ART

In the context of the present invention, actinic radiation means electromagnetic radiation, such as near infrared (NIR), visible light, UV radiation, x-rays and gamma radiation, especially UV radiation, and corpuscular radiation, such as electron beams, beta radiation, proton beams, alpha radiation, and neutron beams, especially electron beams.

In the context of the present invention the term “(meth)acrylate copolymers” encompasses acrylate copolymers, methacrylate copolymers, and mixed acrylate and methacrylate copolymers. Correspondingly the term “(meth)acrylate” embraces, respectively, monomeric acrylates, methacrylates, and mixtures of acrylates and methacrylates, or acrylate groups, methacrylate groups, and acrylate and methacrylate groups. In the same way the term “(meth)acryloyl (group)” encompasses acryloyl (groups), methacryloyl (groups), and mixtures of acryloyl (groups) and methacryloyl (groups).

Copolymers containing on average at least one primary or secondary carbamate group and at least one group which can be activated with actinic radiation are known from international patent application WO 01/46285.

The known copolymers are prepared by
1. in a first variant
   1.1 in a first process step, reacting at least one polyfunctional compound having at least two isocyanate-reactive, acid-reactive or epoxide-reactive functional groups with in each case at least one compound which has an isocyanate group, acid group or epoxide groups and also at least one bond which can be activated with actinic radiation, and thereafter, in a second process step, reacting the resultant intermediate, which on average still has at least one free isocyanate-reactive, acid-reactive or epoxide-reactive functional group, with in each case at least one compound by means of which carbamate groups are introduced; or
   1.2 in a first process step, reacting at least one polyfunctional compound having at least two isocyanate-reactive, acid-reactive or epoxide-reactive functional groups with in each case at least one compound by means of which carbamate groups are introduced, and then, in a second process step, reacting the resultant intermediate, which still has on average at least one free isocyanate-reactive, acid-reactive or epoxide-reactive functional group, with in each case at least one compound which has an isocyanate group, acid group or epoxide groups and also at least one bond which can be activated with actinic radiation;
2. in a second variant
   2.1 in a first process step, reacting at least one polyisocyanate, polyacid or polyepoxide with in each case at least one compound which has at least one bond which can be activated with actinic radiation and also one isocyanate-reactive, acid-reactive or epoxide-reactive functional group, and thereafter reacting the resultant intermediate, which on average still has at least one isocyanate group, acid group or epoxide group, in a second process step, with in each case at least one compound which has at least one carbamate group or at least one functional group which can be converted into carbamate groups, and one isocyanate-reactive, acid-reactive or epoxide-reactive functional group; or
   2.2 in a first process step, reacting at least one polyisocyanate, polycarboxylic acid or polyepoxide with in each case at least one compound which has at least one carbamate group or at least one functional group which can be converted into carbamate groups, and also one isocyanate-reactive, acid-reactive or epoxide-reactive functional group, and thereafter reacting the resultant intermediate, which on average still has at least one isocyanate group, acid group or epoxide group, in a second process step, with in each case at least one compound which has at least one bond which can be activated with actinic radiation and also one isocyanate-reactive, acid-reactive or epoxide-reactive functional group; or
3. in a third variant, reacting at least one polyisocyanate, polyacid or polyepoxide in a one-pot process with at least one compound which has at least one carbamate group or at least one functional group which can be converted into carbamate groups, and also one isocyanate-reactive, acid-reactive or epoxide-reactive functional group, and with at least one compound which has at least one bond which can be activated with actinic radiation and also one isocyanate-reactive, acid-reactive or epoxide-reactive functional group.

Further information on the details of the synthesis and of the structure of the resulting copolymers, particularly the (meth)acrylate copolymers, is not given.

The known copolymers are used for preparing materials which can be cured thermally and with actinic radiation. As is known, the joint use of thermal curing and of radiation curing is also referred to by those in the art as “dual cure”.

The known dual-cure materials serve in particular for producing dual-cure thermoset materials.

With the known mode of preparation it is a drawback that not only the carbamate groups but also the groups which can be activated with actinic radiation have to be introduced subsequently, by means of polymer-analogous reactions, into reactive oligomers or polymers formed beforehand. These polymer-analogous reactions, however, may be accompanied by unwanted side reactions, such as degradation of the oligomeric or polymeric starting compounds, reactions of the starting compounds with themselves, and/or instances of crosslinking and gelling.

These unwanted side reactions may lead to a situation in which the resulting known copolymers are suitable only with restrictions, or are totally unsuitable, for the preparation of materials curable thermally and with actinic radiation, on account of the fact that they have, for example, discolorations, gel specks and/or an undesirably high viscosity, with the consequences that the thermoset materials produced from them do not meet exacting demands and are unsuitable for end uses which pose a particular technical and/or esthetic challenge.

Problem Addressed

The present invention is based on the object of providing new copolymers, containing lateral carbamate groups and groups which can be activated with actinic radiation, that no longer have the drawbacks of the prior art.

The new copolymers containing lateral carbamate groups and groups which can be activated with actinic radiation ought to be preparable in a particularly simple and very well-reproducible way in fewer process steps. They ought to contain no byproducts or only very small amounts—that is, amounts not relevant technically—of byproducts. At the same time their profile of performance properties ought to be easy to tailor and to vary and optimize.

The new copolymers containing lateral carbamate groups and groups which can be activated with actinic radiation ought to have particularly broad usefulness. In particular they ought to be especially suitable as materials curable thermally and with actinic radiation, or for preparing such materials.

The new dual-cure materials ought to exhibit discolorations and gel specks either not at all or only to a very small extent—that is, an extent not relevant technically. They ought to have very good processing and application properties. They ought to have particularly broad usefulness. In particular they ought to be suitable for use as liquid and solid dual-cure coating materials, particularly dual-cure electrocoat, primer, surfacer, primer-surfacer, solid-color topcoat, basecoat and clearcoat materials, especially dual-cure clearcoat materials, or for preparing such materials.

The new dual-cure materials ought to provide new thermoset materials cured thermally and with actinic radiation, particularly new coatings, and especially new electrocoats, primers, surfacers and undercoats, solid-color topcoats, basecoats, and clearcoats, especially clearcoats, having excellent performance properties. In particular the new thermoset materials, particularly the new coatings, ought not to exhibit any defects, such as discolorations or gel specks, so that they are suitable also for end uses which pose particularly technical challenges and particularly esthetic challenges, such as automobile OEM finishing and automotive refinish, including line refinish.

Specifically the new clearcoats ought to have the quality known as automobile quality as is defined in European patent EP 0 352 298 B1, page 15, line 42, to page 17, line 40.

Solution

Found accordingly have been the new copolymers (A) containing lateral, primary and/or secondary carbamate groups and groups which can be activated with actinic radiation, and preparable by

I. in a first process step copolymerizing
(a1) at least one monomer containing
   (a11) at least one group of the general formula I:

CH₂═C(R)C(O)—O— (I),
in which the variable R is a hydrogen atom, a halogen atom, a nitrile group or an alkyl group having 1 to 10 carbon atoms, and
(a12) at least one primary and/or secondary carbamate group,
and
(a2) at least one monomer containing
   (a21) at least one free-radically or ionically polymerizable, olefinically unsaturated double bond and
   (a22) at least one reactive functional group which is not reactive with the carbamate groups (a12) and is not polymerizable with the double bond (a21),
to give the copolymer (a1/a2), and

II. in a further process step, reacting the copolymer (a1/a2) with
(a3) at least one compound containing
   (a31) at least one group which can be activated with actinic radiation and
   (a32) at least one reactive functional group complementary to the reactive functional group (a22),
to give the copolymer (A).

The new copolymers (A) containing lateral, primary and/or secondary carbamate groups and groups which can be activated with actinic radiation are referred to below as “copolymers (A) of the invention”.

Also found has been the new process for preparing copolymers (A) containing lateral, primary and/or secondary carbamate groups (a12) and groups (a31) which can be activated with actinic radiation, which involves

I. in a first process step copolymerizing
(a1) at least one monomer containing
   (a11) at least one group of the general formula I:

CH₂═C(R)C(O)—O— (I),
in which the variable R is a hydrogen atom, a halogen atom, a nitrile group or an alkyl group having 1 to 10 carbon atoms, and
(a12) at least one primary and/or secondary carbamate group,
and
(a2) at least one monomer containing
   (a21) at least one free-radically or ionically polymerizable, olefinically unsaturated double bond and
   (a22) at least one reactive functional group which is not reactive with the carbamate groups (a12) and is not polymerizable with the double bond (a21),
to give the copolymer (a1/a2), and

II. in a further process step, reacting the copolymer (a1/a2) with
(a3) at least one compound containing
   (a31) at least one group which can be activated with actinic radiation and
   (a32) at least one reactive functional group complementary to the reactive functional group (a22),
to give the copolymer (A).

The new process for preparing copolymers (A) containing lateral, primary and/or secondary carbamate groups and groups which can be activated with actinic radiation is referred to below as “process of the invention”.

Found not least has been the new use of the copolymers (A) of the invention and of the copolymers (A) prepared by the process of the invention as materials curable thermally and with actinic radiation or for preparing such materials, this being referred to below as “use in accordance with the invention”.

Further subject matter of the invention will become apparent from the description.

### ADVANTAGES OF THE INVENTION

In the light of the prior art it was surprising and unforeseeable for the skilled worker that the object on which the present invention was based could be achieved by means of the copolymers (A) of the invention, of the process of the invention, and of their use in accordance with the invention.

Surprisingly, the copolymers (A) of the invention no longer had the drawbacks of the prior art.

They were able to be prepared in a particularly simple and very well-reproducible way, in particular by the process of the invention, in fewer process steps than the customary, known copolymers. They contained no byproducts or only very small amounts—that is, amounts which are not technically relevant—of byproducts. At the same time their profile of performance properties was easy to tailor and vary and optimize.

The copolymers (A) of the invention had particularly broad usefulness. In particular they were suitable, in the context of their use in accordance with the invention, to a particular extent as new materials curable thermally and with actinic radiation (dual-cure materials) or for preparing such materials.

The dual-cure materials of the invention exhibited discolorations and gel specks either not at all or only to a very small extent—that is, an extent not relevant technically. They had very good processing and application properties. They had particularly broad usefulness. In particular they were suitable for use as new liquid and solid dual-cure coating materials, particularly new dual-cure electrocoat, primer, surfacer, primer-surfacer, solid-color topcoat, basecoat and clearcoat materials, especially dual-cure clearcoat materials, or for preparing such materials.

The dual-cure materials of the invention gave new thermoset materials cured thermally and with actinic radiation, particularly new coatings, and especially new electrocoats, primers, surfacers and undercoats, solid-color topcoats, basecoats, and clearcoats, especially clearcoats, having excellent performance properties. In particular the thermoset materials of the invention, especially the coatings of the invention, exhibited no defects, such as discolorations or gel specks, so that they were suitable also for end uses which pose particularly technical challenges and particularly esthetic challenges, such as automobile OEM finishing and automotive refinish, including line refinish.

The clearcoats of the invention, especially, exhibited the quality referred to as automobile quality as defined in European patent EP 0 352 298 B1, page 15, line 42, to page 17, line 40.

### DETAILED DESCRIPTION OF THE INVENTION

The copolymers (A) of the invention contain lateral, i.e., pendant, primary and/or secondary, preferably primary, carbamate groups (a12). Preferably they contain on average more than two, more preferably more than three, and in particular more than four carbamate groups (a12) per molecule.

They may additionally contain at least one terminal, i.e., end-positioned, primary and/or secondary, preferably primary, carbamate group (a12).

Preferably the copolymers (A) of the invention contain predominantly lateral carbamate groups (a12); in other words, there is at least one more lateral carbamate group (a12) than terminal carbamate groups (a12).

The nitrogen atoms of the secondary carbamate groups (a12) are substituted by a monovalent organic radical (a121). Suitable radicals (a121) include all monovalent organic radicals which under the usual, known conditions of copolymerization initiated thermally and/or with actinic radiation and of the reactions of the carbamate groups (a121) with complementary reactive functional groups are inert, which is to say that they do not enter into any side reactions and/or do not inhibit the desired reactions.

The monovalent organic radicals (a121) are preferably selected from the group consisting of alkylaryl-, arylalkyl-, alkylcycloalkyl-, cycloalkylalkyl-, arylcycloalkyl-, cycloalkylaryl-, alkylcycloalkylaryl-, alkylarylcycloalkyl-, arylcycloalkylalkyl-, arylalkylcycloalkyl-, cycloalkylalkylaryl-, and cycloalkylarylalkyl-radicals
unsubstituted or substituted by at least one radical (a1211),
containing at least one at least divalent, especially divalent, heteroatom (a1212) or free from heteroatoms, and
containing at least one at least divalent, especially divalent, linking functional group (a1213) or free from such groups,

the hyphen symbolizing in each case the covalent bond between a carbon atom of a radical and the nitrogen atom of the carbamate group.

Suitable radicals (a1211) include all usual, known electron-withdrawing and electron-donating atoms and monovalent organic radicals which are inert in the sense outlined above. Examples of suitable radicals (a1211) are halogen atoms, such as fluorine, chlorine, bromine or iodine, or nitrile groups or nitro groups.

Suitable divalent heteroatoms (a1212) include, in particular, oxygen atoms and sulfur atoms, present for example in radicals (a121) containing ether groups and/or thioether groups.

Suitable at least divalent, especially divalent, linking functional groups (a1213) include all of the usual, known functional groups in organic chemistry which are inert in the sense stated above, such as, for example, carboxylic ester, thiocarboxylic ester, carbonate, thiocarbonate, phosphoric ester, thiophosphoric ester, phosphonic ester, thiophosphonic ester, phosphite, thiosphosphite, sulfonic ester, amide, amine, thioamide, phosphoramide, thiophosphoramide, phosphonamide, thiophosphonamide, sulfonamide, imide, urethane, hydrazide, urea, thiourea, carbonyl, thiocarbonyl, sulfone, sulfoxide, or siloxane groups.

The monovalent organic radicals (a121) are preferably unsubstituted. They are preferably free from heteroatoms (a1212). With particular preference they contain no linking functional groups (a1213). With very particular preference they are unsubstituted and free from heteroatoms (a1212) and functional groups (a1213).

In particular the radicals (a121) are selected from the group consisting of methyl, ethyl, propyl, isopropyl, n-butyl, isobutyl, tert-butyl, n-pentyl, amyl, hexyl, cyclopentyl, cyclohexyl, and phenyl.

The copolymers (A) of the invention contain lateral groups (a31) which can be activated with actinic radiation, in particular with UV radiation and/or electron beams. Preferably they contain on average at least two, preferably at least three, and in particular at least four lateral groups (a31) which can be activated with actinic radiation.

In addition they may contain at least one terminal group (a31) which can be activated with actinic radiation.

“Group which can be activated with actinic radiation” means for the purposes of the present invention that a group (a31) contains at least one, especially one, bond (a311) which by virtue of supply of energy by means of actinic radiation is placed in a position to enter into chemical reactions, such as the usual, known photoreactions, cyclizations, insertion reactions or free-radical or ionic polymerizations.

The bonds (a311) which can be activated with actinic radiation are preferably selected from the group consisting of single carbon-hydrogen bonds, single and double carbon-carbon, carbon-oxygen, carbon-nitrogen, carbon-phosphorus, and carbon-silicon bonds, and triple carbon-carbon bonds. In particular, double carbon-carbon bonds are used.

The bonds (a311) which can be activated with actinic radiation may be present in any of a very wide variety of usual, known organic groups (a31). The groups (a31) which can be activated with actinic radiation are preferably selected from the group consisting of (meth)acrylate, ethacrylate, crotonate, cinnamate, vinyl ether, vinyl ester, ethenylarylene, dicyclopentadienyl, norbornenyl, isoprenyl, isopropenyl, allyl and butenyl groups; ethenylarylene ether, dicyclopentadienyl ether, norbornenyl ether, isoprenyl ether, isopropenyl ether, allyl ether, and butenyl ether groups; and ethenylarylene ester, dicyclopentadienyl ester, norbornenyl ester, isoprenyl ester, isopropenyl ester, allyl ester, and butenyl ester groups, more preferably (meth)acrylate groups, and especially acrylate groups.

Besides the aforementioned groups (a12) and (a31), the copolymers (A) of the invention may further contain at least one functional group (a41), different from the groups (a12) and (a31), which can be introduced into the copolymers (A) of the invention by means of
1. the copolymerization of a monomer (a4) different from the monomers (a1) and (a2) and containing
   1.1 at least one of the free-radically or ionically polymerizable, olefinically unsaturated double bonds (a21) described below or at least one of the groups (a11) of the general formula I described below, and
   1.2 at least one functional group (a41) which is not polymerizable with the double bonds (a21) and the groups (a11) and which reacts only very slowly, if at all, under the conditions
      of the preparation of the copolymers (a1/a2) described below and
      of their reaction with the compounds (a3), described below, containing the above-described carbamate group (a12) and the below-described reactive functional groups (a22) and (a32);
   and/or
2. the reaction of the copolymers (a1/a2) described below, with at least one compound (a6) containing
   2.1 at least one of the functional groups (a41) described above and
   2.2 at least one reactive functional group (a32) complementary to the reactive functional groups (a22) described below.

The skilled worker is able with ease to select the monomers (a4) and the compounds (a6) by virtue of his or her general art knowledge, on the basis of the reactivity, with which he or she is familiar, of the groups (a12), (a22), and (a32) on the one hand and of the groups (a41) on the other.

The copolymers (A) of the invention contain the groups (a41), where present, preferably only in minor amounts, i.e., in amounts which, while varying the profile of properties essential to the invention, which is characterized by the mandatory carbamate groups (a12) and groups (a11) which can be activated with actinic radiation, do not alter it to such an extent that it is determined primarily by the groups (a41). Under such conditions the equivalent ratio is preferably [(a11)+(a31)]:(a41)>2, more preferably >5, and in particular >10.

The number-average molecular weight Mn, the mass-average molecular weight Mw, and the polydispersity P of the copolymers (A) of the invention can vary very widely and are guided by the requirements of the particular field of application. Where, for example, a certain application requires solid copolymers (A) of the invention which can be processed as thermoplastics, the copolymers have comparatively high molecular weights Mn and Mw. Where, contrastingly, a certain application requires copolymers (A) of the invention which are liquid at comparatively low temperatures, especially room temperature, these copolymers have comparatively low molecular weights Mn and Mw.

The copolymers (A) of the invention preferably have a number-average molecular weight Mn of 500 to 250 000 daltons, more preferably 1 000 to 200 000 daltons, very preferably 1 500 to 150 000 daltons, with particular preference 1 500 to 100 000 daltons, and in particular 1 500 to 50 000 daltons.

The copolymers (A) of the invention preferably have a mass-average molecular weight Mw of 1 000 to 500 000 daltons, more preferably 2 000 to 400 000 daltons, very preferably 2 500 to 300 000 daltons, with very particular preference 2 500 to 200 000 daltons, and in particular 2 500 to 100 000 daltons.

The polydispersity P of the molecular weight is preferably small. P is more preferably <15, very preferably <10, with very particular preference <8, and in particular <5.

The copolymers (A) of the invention can be prepared per se by any of a very wide variety of processes. With preference, however, the copolymers (A) of the invention are prepared by means of the process of the invention.

The process of the invention involves

I. in a first process step copolymerizing
(a1) at least one, especially one, monomer containing
   (a11) at least one, especially one, group of the general formula I:

CH₂═C(R)C(O)—O— (I),
in which the variable R is a hydrogen atom, a halogen atom, a nitrile group or an alkyl group having 1 to 10 carbon atoms, and
(a12) at least one, especially one, of the above-described primary and/or secondary, especially primary, carbamate groups,
and
(a2) at least one monomer, especially at least two monomers, containing
   (a21) at least one, especially one, free-radically or ionically polymerizable, olefinically unsaturated double bond and
   (a22) at least one, especially one, reactive functional group which is not reactive with the carbamate groups (a12) and is not polymerizable with the double bond (a21),
to give the copolymer (a1/a2), and

II. in a further process step, reacting the copolymer (a1/a2) with
(a3) at least one, especially one, compound containing
   (a31) at least one, especially one, group which can be activated with actinic radiation, in particular UV radiation and/or electron beams, and
   (a32) at least one, especially one, reactive functional group complementary to the reactive functional group (a22),
to give the copolymer (A).

Monomer (a1) for use in accordance with the invention contains the group (a11) of the general formula I.

In the general formula I the radical R is preferably a hydrogen atom, chlorine atom, bromine atom, iodine atom, a nitrile group or an alkyl group having 1 to 6 carbon atoms. In particular the radical R is a hydrogen atom or a methyl group.

In the monomers (a1) which are used with preference in accordance with the invention the groups (a11) of the general formula I and the carbamate groups (a12) are preferably attached via a divalent linking group (a13) which is inert in the sense stated above.

The groups (a13) are preferably selected from the group consisting of

aliphatic, cycloaliphatic, aromatic, aliphatic-cycloaliphatic, aliphatic-aromatic, cycloaliphatic-aromatic, and aliphatic-cycloaliphatic-aromatic groups
unsubstituted or substituted by at least one radical (a131),
containing at least one at least divalent, especially divalent, heteroatom (a132) or free from heteroatoms, and
containing at least one at least divalent, especially divalent, linking functional group (a133) or free from such groups.

Examples of suitable radicals (a131) are the above-described radicals (a1211).

Examples of suitable heteroatoms (a132) are the above-described heteroatoms (a1212).

Examples of suitable linking functional groups (a133) are the above-described groups (a1213).

Examples of suitable groups (a13) are known from international patent application WO 03/016411, page 8, line 22, to page 10, line 18.

The monomers (a1) are usual, known products, some of which are available commercially.

Examples of suitable monomers (a1) and of processes for preparing them are known from the American patents
U.S. Pat. No. 3,479,328, column 1, line 11, to column 5, line 30, column 7, lines 19 to 53, and column 8, line 61, to column 9, line 6, and
U.S. Pat. No. 3,674,838, column 1, line 9, to column 4, line 75, and column 5, line 20, to column 6, line 21.

The (a1) monomer N-butyl-O-ethylurethane acrylate is sold under the brand name Ebecryl® CL 1039 by UCB.

Monomer (a2) contains the free-radically or ionically—i.e., cationically or anionically—polymerizable, olefinically unsaturated double bond (a21).

Examples of suitable olefinically unsaturated double bonds (a21) are the above-described double carbon-carbon bonds (a311) which can be activated with actinic radiation and which are preferably present in the above-described groups (a31) which can be activated with actinic radiation. In particular the olefinically unsaturated double bonds (a21) are present in the (meth)acryloyl groups and/or in the ethenylarylene groups. Examples of suitable ethenylarylene groups are known from the German patent application
DE 199 48 004 A1, page 10, lines 6 to 13, in conjunction with page 8, line 23, to page 9, line 31.

In particular, (meth)acryloyl groups are used.

Monomer (a2) contains the reactive functional group (a22) which is non-reacting with the carbamate groups (a12) and is not polymerizable with the double bond (a21). “Non-reacting” means that, under the conditions of free-radical or ionic polymerization and under the conditions of storage and handling of the resulting copolymers (a1/a2), the groups (a22) react only very slowly, if at all, with the carbamate groups (a12).

Suitable groups (a22) include in principle all reactive functional groups of organic chemistry that have the above profile of properties. The groups (a22) are preferably selected from the group consisting of hydroxyl groups, thiol groups, primary and secondary amino groups, acid groups, especially sulfonic acid, phosphonic acid, acidic sulfate ester, acidic phosphate ester, and carboxyl groups, epoxide groups, carboxamide groups, carbonyl halide groups, especially carbonyl chloride groups, carbonyl groups in aldehyde or ketone function, and isocyanate groups. In particular, carboxyl groups or epoxide groups (a22) are used.

In the monomers (a2) the olefinically unsaturated double bonds (a21) or the groups which contain the olefinically unsaturated double bonds (a21), on the one hand, and the reactive functional groups (a22) on the other hand, may be linked to one another directly or via one of the above-described, especially divalent, inert linking functional groups (a13).

Examples of suitable monomers (a2) are known from the patent applications
DE 199 48 004 A1, page 8, line 23, to page 9, line 40, page 11, lines 33 to 48, page 11, line 65, to page 12, line 6, and page 12, lines 22 to 30,
WO 03/016411, page 22, line 25, to page 23, line 21, or
EP 0 650 970 A1, column 5, lines 10 to 39, and column 6, lines 35 to 48.

In step I of the process the monomers (a1) and (a2) are copolymerized to give the copolymers (a1/a2).

Preferably, in addition, at least one further monomer (a4) which is copolymerizable free-radically or ionically, preferably free-radically, with the monomers (a1) and (a2) is copolymerized in order to vary the profile of chemical properties of the copolymers (a1/a2) and of the copolymers (A) of the invention advantageously by means of the above-described functional groups (a41).

More preferably, in addition, at least one further monomer (a5) which is copolymerizable free-radically or ionically, preferably free-radically, with the monomers (a1) and (a2) is copolymerized which contains at least one of the above-described, olefinically unsaturated double bonds (a21) and is free from reactive functional groups (a12), (a22), (a32), and (a41). In particular, additionally, at least two of these monomers (a5) are copolymerized. By this means it is possible to vary advantageously the profile of physical properties, especially the glass transition temperature, of the copolymers (A) of the invention.

Examples of suitable monomers (a4) and (a5) are known from the international patent application
WO 03/016411, page 24, line 9, to page 28, line 8.

The preparation of the copolymers (a1/a2) in step I of the process of the invention has no special features in terms of method but can instead be carried out as described in the patent applications
WO 03/016411, page 29, line 3, to page 30, line 15, or
DE 198 50 210 A1, page 4, line 48, to page 5, line 35.

In step II of the process of the invention the copolymers (a1/a2) are reacted with the compound (a3).

Examples of suitable groups (a31) which can be activated with actinic radiation for the compounds (a3) are the above-described groups which can be activated with actinic radiation, containing bonds (a311) which can be activated with actinic radiation.

Examples of suitable reactive functional groups (a32) complementary to the reactive functional group (a22) are known from patent applications
WO 03/016411, page 26, line 1, to page 22, line 18, or
EP 0 650 970 A1, column 5, lines 10 to 39, and column 6, lines 35 to 48.

The complementary reactive functional groups (a32) are preferably selected from the group consisting of hydroxyl groups, thiol groups, primary and secondary amino groups, N-hydroxyalkylamino groups, N-alkoxyalkylamino groups, acid groups, epoxide groups, and isocyanate groups.

As pairs of complementary reactive functional groups (a22)/(a32) it is preferred to use
hydroxyl groups, thiol groups or primary and secondary amino groups on the one hand and isocyanate groups on the other hand, or
amino groups or carboxyl groups on the one hand and epoxide groups on the other hand.

Use is made in particular of carboxyl groups on the one hand and epoxide groups on the other hand.

In the compounds (a3) the groups (a31) which can be activated with actinic radiation and the reactive functional groups (a32) may be linked to one another directly or via one of the above-described divalent, inert, linking, functional groups (a13). Accordingly the above-described monomers (a2) may be used as compounds (a3). For further details refer to European patent application EP 0 650 979 A1, column 6, lines 25 to 48.

In particular in the case of using (meth)acrylic acid as monomer (a2) glycidyl(meth)acrylate is used as compound (a3), and, conversely, in the case of using glycidyl(meth)acrylate as monomer (a2), (meth)acrylic acid is used as compound (a3).

In process step II the copolymers (a1/a2) can be reacted not only with the compounds (a3) but also with the above-described compounds (a6) in order to introduce the above-described functional groups (a41), selected as described, into the copolymers (A) of the invention.

Viewed in terms of method, the polymer-analogous reaction of the copolymers (a1/a2) with the compounds (a3) and also, if desired, the compounds (a5) in step II of the process of the invention has no special features but instead takes place preferably by mixing of the above-described starting compounds in suitable mixing apparatus, such as stirred tanks, agitator mills, extruders, compounders, Ultraturrax, inline dissolvers, static mixers, micromixers, toothed-wheel dispersers, pressure release nozzles and/or microfluidizers. It is preferred here to operate in the absence of light with a wavelength λ<550 nm or in complete absence of light, in order to prevent premature crosslinking of the copolymers (A) of the invention.

The polymer-analogous reaction of process step II takes place preferably at temperatures of 0 to 200° C., more preferably 20 to 150° C., and in particular 30 to 120° C. It is preferred in this case to use customary, known catalysts for the reaction of the complementary reactive functional groups (a22) and (a32). Examples of suitable catalysts are described in European patent application EP 0 650 979 A1, column 6, line 56, to column 7, line 7. With particular preference the polymer-analogous reaction is carried out in the presence of customary, known inhibitors of thermal crosslinking and of free-radical polymerization. Examples of suitable inhibitors are known from European patent application EP 0 650 979 A1, column 6, lines 20 to 27. With very particular preference the equivalent ratio (a22):(a32) employed for the polymer-analogous reaction is 0.5 to 1.5, preferably 0.7 to 1.3, more preferably 0.8 to 1.2, and in particular 0.9 to 1.1.

The resultant copolymers (A) of the invention, in particular the (meth)acrylate copolymers (A) of the invention, enjoy particularly broad usefulness. By way of example they can be used as thermoplastic materials. In particular they are especially suitable as materials curable thermally and with actinic radiation (dual-cure materials) or for preparing such materials, in which case they take on preferably the function of binders (cf. Römpp Lexikon Lacke und Druckfarben, Georg Thieme Verlag, Stuttgart, New York, 1998, “Binders”).

The dual-cure materials of the invention exhibit very little, if any, discoloration and gel specks—that is, they exhibit levels of discoloration and of gel specks that are irrelevant from a technical standpoint. They have very good processing and application properties. They are of particularly broad usefulness. In particular they are suitable as new, liquid and solid dual-cure coating materials, especially dual-cure electrocoat, primer, surfacer, primer-surfacer, solid-color topcoat, basecoat, and clearcoat materials, especially dual-cure clearcoat materials, or for preparing such materials. Additionally they are suitable for use as new dual-cure adhesives and sealants for producing new adhesive layers and seals. They are suitable not least for producing new moldings and self-supporting sheets.

The dual-cure materials of the invention may include all of the customary, known constituents of dual-cure materials, such as are known, for example, from German patent
DE 197 09 467 C 1, page 4, line 30, to page 6, line 30,

or from the patent applications
WO 03/016411, page 33, line 6, to page 35, line 19,
DE 199 48 004 A1, page 14, line 4, to page 17, line 5, or
DE 100 48 849 A1, page 5, paragraphs [0053] to [0055].

By means of these constituents their profile of properties can be varied broadly in an advantageous way. For example, following the addition of customary, known thermally activatable initiators, such as peroxides, azo compounds and C—C-labile compounds, TPP, the dual-cure materials of the invention can also be cured by means of heat alone.

The dual-cure materials of the invention are preferably prepared by mixing the above-described constituents in suitable mixing apparatus, such as stirred tanks, agitator mills, extruders, compounders, Ultraturrax, inline dissolvers, static mixers, micromixers, toothed-wheel dispersers, pressure release nozzles and/or microfluidizers. It is preferred here to operate in the absence of light with a wavelength X<550 nm or in complete absence of light, in order to prevent premature crosslinking of the materials of the invention.

The dual-cure materials of the invention may be present in any of a very wide variety of aggregate states. Hence they are conventional materials comprising organic solvents, aqueous materials, substantially or entirely solvent- and water-free liquid materials (100% systems), substantially or entirely solvent- and water-free solid powders, or substantially or entirely solvent-free powder suspensions (powder slurries). Additionally they may be one-component systems, in which the binders and the crosslinking agents are present alongside one another, or two-component or multicomponent systems, in which the binders and the crosslinking agents are present separately from one another until shortly before application.

The dual-cure materials of the invention give new thermoset materials cured thermally and with actinic radiation, particularly new coatings, and especially new electrocoats, primers, surfacers and undercoats, solid-color topcoats, basecoats, and clearcoats, especially clearcoats, and also new adhesive layers, seals, moldings, and self-supporting sheets, having excellent performance properties. In particular the new thermoset materials, especially the new coatings, exhibit no defects, such as discolorations or gel specks, so that they are also suitable for end uses which present particular challenges from a technical and esthetic standpoint, such as automotive OEM finishing and automotive refinish, including line refinish.

To produce the thermoset materials of the invention the dual-cure materials of the invention are applied to customary, known temporary or permanent substrates.

For producing the sheets and moldings of the invention it is preferred to use customary, known temporary substrates, such as metallic and plastic belts or hollow bodies made of metal, glass, plastic, wood or ceramic, which can be easily removed without damaging the sheets and moldings of the invention.

Where the dual-cure materials of the invention are used for producing the coatings, adhesive layers, and seals of the invention, use is made of permanent substrates, such as means of transport, especially aircraft, boats, rail vehicles, motor vehicles, and parts thereof; the interior and exterior of buildings and parts thereof; doors, windows, and furniture; hollow glassware; coils; containers and packaging; small industrial parts; optical components, electrical components, and mechanical components, and also components for white goods. The sheets and moldings of the invention may likewise serve as substrates.

In terms of method the application of the liquid dual-cure materials of the invention has no special features but can instead take place by all customary, known application methods, such as injecting, spraying, knife coating, brushing, casting, dipping, trickling or rolling, for example.

Application of the dual-cure materials of the invention that are in powder form also has no special features in terms of method, but instead takes place, for example, by the customary, known fluidized-bed methods, such as are known, for example, from the BASF Coatings AG publications “Pulverlacke für industrielle Anwendungen” [Powder coatings for industrial applications], January 2000, or “Coatings Partner, Pulverlack Spezial” [Coatings partner, powder coatings special”, 1/2000, or Römpp Lexikon Lacke und Druckfarben, Georg Thieme Verlag, Stuttgart, New York, 1998, pages 187 and 188, “Electrostatic Powder spraying”, “Electrostatic spraying”, and “Electrostatic fluidizing bath method”.

In the course of application it is advisable to operate in the absence of actinic radiation, in order to prevent premature crosslinking of the dual-cure materials of the invention.

The applied dual-cure materials of the invention are preferably cured using UV radiation. In the course of irradiation it is preferred to use a radiation dose of 100 to 6 000, more preferably 200 to 3 000, very preferably 300 to 2 000, and especially preferably 500 to 1 800 mJ cm⁻², the region <1 700 mJ cm⁻² being very particularly preferred.

The radiation intensity here may vary widely. It is guided in particular by the radiation dose, on the one hand, and the irradiation time, on the other. For a given radiation dose, the irradiation time is guided by the belt speed or rate of advance of the substrates in the irradiation unit, and vice versa.

UV radiation sources which can be used include all customary, known UV lamps. Flash lamps are also suitable.

As UV lamps it is preferred to use mercury vapor lamps, more preferably low-pressure, medium-pressure, and high-pressure mercury vapor lamps, especially medium-pressure mercury vapor lamps. Particular preference is given to using unmodified mercury vapor lamps plus appropriate filters, or modified mercury vapor lamps, especially those modified by doping.

Preference is given to using gallium-doped and/or iron-doped, especially iron-doped, mercury vapor lamps, as described for example in R. Stephen Davidson, “Exploring the Science, Technology and Applications of U.V. and E.B. Curing”, Sita Technology Ltd., London, 1999, Chapter I, “An Overview”, page 16, FIG. 10, or Dipl.-Ing. Peter Klamann, “eltosch System-Kompetenz, UV-Technik, Leitfaden für Anwender” [Eltosch systems expertise, UV technology, principles for users], page 2, October 1998. Used in particular in this context is UV radiation having the spectral distribution described in German patent application DE 102 02 565 A1.

Examples of suitable flash lamps are flash lamps from the company VISIT.

The distance of the UV radiation sources from the applied dual-cure materials of the invention may vary surprisingly widely and can therefore be adjusted very well to the requirements of the case in hand. The distance is preferably 2 to 200, more preferably 2 to 100, very preferably 2 to 50, and in particular 2 to 30 cm. The arrangement of the sources may also be adapted to the circumstances of the substrate and the process parameters. In the case of substrates of complex shape, such as are envisaged for automobile bodies, those areas not accessible to direct radiation (shadow regions), such as cavities, folds and other structural undercuts, can be cured using pointwise, small-area or all-round emitters, in conjunction with an automatic movement means for the irradiation of cavities or edges.

Irradiation can be carried out under an oxygen-depleted atmosphere. “Oxygen-depleted” means that the oxygen content of the atmosphere is lower than the oxygen content of air (20.95% by volume). The atmosphere may in principle also be oxygen-free—in other words, an inert gas. Owing to the lack of the inhibiting effect of oxygen, however, this may cause a sharp acceleration in radiation curing, as a result of which inhomogeneities and stresses may arise in the thermoset materials of the invention. It is therefore of advantage not to lower the oxygen content of the atmosphere to zero percent by volume.

With regard to the dual-cure materials of the invention, the thermal cure may take place for example with the aid of a gaseous, liquid and/or solid, hot medium, such as hot air, heated oil or heated rollers, or by means of microwave radiation, infrared light and/or near infrared (NIR) light. Heating preferably takes place in a forced-air oven or by exposure to IR and/or NIR lamps. As in the case of curing with actinic radiation, the thermal cure may also take place in stages. The thermal cure takes place advantageously at temperatures from room temperature through 200° C.

Where near infrared (NIR) is used for the cure, the dual cure may also take place in one step (cf., e.g., the American patent U.S. Pat. No. 6,432,490 B1).

Both the thermal cure and the actinic radiation cure may be carried out in stages. They may take place one after another (sequentially) or simultaneously. In the case of sequential curing the dual-cure materials of the invention may be cured first thermally and then with actinic radiation or first with actinic radiation and then thermally. All curing steps may also be carried out two or more times.

The resultant sheets, moldings, coatings, adhesive layers, and seals of the invention are outstandingly suitable for coating, bonding, sealing, wrapping, and packaging means of transport, such as aircraft, boats, rail vehicles, motor vehicles, and parts thereof; the interior and exterior of buildings and parts thereof; doors, windows, and furniture; hollow glassware; coils; containers and packaging; small industrial parts, such as nuts, bolts, wheel rims or hub caps; electrical components, such as windings (coils, stators, rotors); optical components; mechanical components; and components for white goods, such as radiators, household appliances, refrigerator casings or washing machine casings.

In particular, however, the dual-cure materials of the invention are used as coating materials of the invention, preferably as topcoat or clearcoat materials of the invention, especially as clearcoat materials of the invention, for producing new, color and/or effect, electrically conductive, magnetically shielding or fluorescent multicoat paint systems, especially multicoat color and/or effect paint systems. The multicoat paint systems of the invention can be produced using customary, known wet-on-wet techniques and paint systems, as are described for example in German patent application DE 199 48 004 A1, page 17, line 37, to page 18, line 2, page 18, lines 36 to 50, and page 18, line 66, to page 19, line 3.

The resultant clearcoats of the invention are the outermost coats of the multicoat paint systems of the invention, substantially determining the overall visual appearance and protecting the color and/or effect coats from mechanical and chemical damage and from damage by radiation. Consequently, any deficiencies in hardness, scratch resistance, chemical resistance, and yellowing stability in the clearcoat are manifested to a particularly marked extent. However, the clearcoats of the invention exhibit no more than a low level of yellowing. They are highly scratch resistant and, after being scratched, exhibit only very low levels of loss of gloss. At the same time they have a high level of hardness. Not least, they have a particularly high chemical resistance and adhere very firmly to the color and/or effect coats. Hence they enjoy the quality referred to as automobile quality, as defined in European patent EP 0 352 298 B1, page 15, line 42, to page 17, line 40.

Overall, the substrates of the invention coated with the coatings of the invention, bonded with the adhesive layers of the invention, sealed with the seals of the invention and/or wrapped or packaged with the sheets and/or moldings of the invention exhibit outstanding long-term service properties and a particularly long service life.

### EXAMPLE

The Preparation of a Methacrylate Copolymer (A)

A heatable stainless steel reactor equipped with stirrer, reflux condenser, and an initiator feedline, a monomer feedline, and a nitrogen inlet tube was charged with 18.54 parts by weight of Solventnaphta® and this initial charge was heated to 158° C. with stirring. At this temperature, 15 minutes after the beginning of the initiator feed (=mixture of 2.95 parts by weight of di-tert-butyl peroxide and 0.48 part by weight of Solventnaphtha®), a monomer mixture of 9.41 parts by weight of styrene, 11.41 parts by weight of N-butyl-O-ethylurethane acrylate, 7.44 parts by weight of butyl methacrylate, 15.4 parts by weight of glycidyl methacrylate, 2.62 parts by weight of hydroxyethyl methacrylate and 10.77 parts by weight of methyl methacrylate was metered in at a uniform rate over the course of four hours. The initiator feed was metered in at a uniform rate over the course of 4.75 hours. During this time the temperature of the reaction mixture was slowly lowered to 135° C. After the end of the initiator feed, polymerization was continued at this temperature until the initiator content was <0.2% by weight, which was generally the case after about 9 hours. Subsequently the resulting solution of the methacrylate copolymer (a1/a2) was cooled to 100° C. and diluted with 20.98 parts by weight of Solventnaphtha®. The solution had a solids content (135° C./one hour) of 60.9% by weight.

A heatable stainless steel reactor equipped with stirrer, reflux condenser, feed vessel, and inlet tube for lean air was charged with 155 parts by weight of the solution of the methacrylate copolymer (a1/a2), corresponding to 88.29 parts by weight of solid resin, 0.1 part by weight of a commercial catalyst (Coscat® Z22 from Rutherford Chemicals) and 0.12 part by weight of methylhydroquinone and this initial charge was heated to 120° C. with stirring. At this temperature, over the course of one hour, 11.49 parts by weight of acrylic acid were metered in at a uniform rate. After the end of the feed the reaction mixture was heated at 120° C. until the acid number had dropped below 4 mg KOH/g.

The resulting solution of the methacrylate copolymer (A) had a solids content (135° C./one hour) of 67.6% by weight and a viscosity (original) at 23° C. of 474 dPas. The methacrylate copolymer (A) had a theoretical hydroxyl number of 113 mg KOH/g and a theoretical double bond content (calculated as >C═C<, 24 daltons) of 4.51% by weight.

The methacrylate copolymer (A) was outstandingly suitable for use as a dual-cure clearcoat material. It was also outstandingly suitable for use as a binder of dual-cure clearcoat materials. These materials had the particular advantage that they were crosslinkable thermally not only via the carbamate groups but also via the hydroxyl groups. They could therefore be varied extraordinarily widely and adapted optimally to any of a very wide variety of different challenges.

The clearcoats produced from these materials and cured thermally and with UV radiation or electron beams had an outstanding profile of performance properties. In particular they were clear, bright, highly glossy, firmly adhering, free from paint defects, such as craters, gel specks, stress cracks, and runs, resistant to abrasion, resistant to scratching, flexible, hard, chemically resistant, moisture resistant, stable to weathering, and resistant to etching. They easily achieved the automobile quality defined in European patent EP 0 352 298 B1, page 15, line 42, to page 17, line 40.

1. A copolymer (A) comprising lateral, primary, or secondary carbamate groups (a12), or a combination thereof, and groups (a31) which can be activated with actinic radiation, prepared by
I. in a first process step copolymerizing
(a1) at least one monomer comprising
(a11) at least one group of the general formula I:
CH₂═C(R)C(O)—O— (I),
wherein R is a hydrogen atom, a halogen atom, a nitrile group or an alkyl group having 1 to 10 carbon atoms, and
(a12) at least one primary carbamate group, secondary carbamate group, or a combination thereof,
and
(a2) at least one monomer comprising
(a21) at least one free-radically or ionically polymerizable, olefinically unsaturated double bond and
(a22) at least one reactive functional group which is not reactive with the carbamate groups (a12) and is not polymerizable with the double bond (a21),
to give a copolymer (a1/a2), and
II. in a further process step, reacting the copolymer (a1/a2) with
(a3) at least one compound comprising
(a31) at least one group which can be activated with actinic radiation and
(a32) at least one reactive functional group complementary to the reactive functional group (a22),
to give the copolymer (A).

2. The copolymer (A) as claimed in claim 1, being a (meth)acrylate copolymer.

3. The copolymer (A) as claimed in claim 1, wherein the groups (a31) which can be activated with actinic radiation can be activated with UV radiations, electron beams, or a combination thereof.

4. (canceled)

5. The copolymer (A) as claimed in claim 4, wherein the group (a11) of the general formula I in the monomer (a1) is connected to the carbamate group (a12) via a divalent linking inert group (a13).

6. The copolymer (A) as claimed in claim 5, wherein the group (a13) is selected from the group consisting of
aliphatic, cycloaliphatic, aromatic, aliphatic-cycloaliphatic, aliphatic-aromatic, cycloaliphatic-aromatic and aliphatic-cycloaliphatic-aromatic groups, which are:
unsubstituted or substituted by at least one radical (a131),
comprising at least one at least divalent, heteroatom (a132) or free from heteroatoms, and
comprising at least one at least divalent, linking functional group (a133) or free from such groups.

7. (canceled)

8. (canceled)

9. The copolymer (A) as claimed in claims 1, wherein the reactive functional group (a22) is selected from the group consisting of hydroxyl groups, thiol groups, primary and secondary amino groups, acid groups, epoxide groups, carboxamide groups, carbonyl halide groups, carbonyl groups in aldehyde function, carbonyl groups in ketone function, and isocyanate groups.

10. (canceled)

11. The copolymer (A) as claimed in claim 1, wherein the group (a31) which can be activated with actinic radiation is selected from the group consisting of groups which comprise at least one bond (a311) which can be activated with actinic radiation.

12. The copolymer (A) as claimed in claim 11, wherein the bonds (a311) which can be activated with actinic radiation are selected from the group consisting of single carbon-hydrogen bonds, single and double carbon-carbon bonds, carbon-oxygen bonds, carbon-nitrogen bonds, carbon-phosphorus bonds, and carbon-silicon bonds, and triple carbon-carbon bonds.

13. The copolymer (A) as claimed in claim 12, wherein the bonds (a311) which can be activated with actinic radiation are double carbon-carbon bonds.

14. The copolymer (A) as claimed in claim 1, wherein the groups (a31) which can be activated with actinic radiation are selected from the group consisting of (meth)acrylate, ethacrylate, crotonate, cinnamate, vinyl ether, vinyl ester, ethenylarylene, dicyclopentadienyl, norbomenyl, isoprenyl, isopropenyl, allyl and butenyl groups; ethenylarylene ether, dicyclopentadienyl ether, norbornenyl ether, isoprenyl ether, isopropenyl ether, allyl ether, and butenyl ether groups; and ethenylarylene ester, dicyclopentadienyl ester, norbornenyl ester, isoprenyl ester, isopropenyl ester, allyl ester, and butenyl ester groups.

15. The copolymer (A) as claimed in claim 14, wherein the groups (a31) which can be activated with actinic radiation are (meth)acrylate groups.

16. (canceled)

17. The copolymer (A) as claimed in claim 1, wherein the complementary reactive functional group (a32) is selected from the group consisting of hydroxyl groups, thiol groups, primary and secondary amino groups, N-hydroxyalkylamino groups, N-alkoxyalkylamino groups, acid groups, epoxide groups, and isocyanate groups.

18. The copolymer (A) as claimed in claim 1, wherein the nitrogen atoms of the secondary carbamate groups (a12) are substituted by a monovalent radical (a121) selected from the group consisting of alkylaryl-, arylalkyl-, alkylcycloalkyl-, cycloalkylalkyl-, arylcycloalkyl-, cycloalkylaryl-, alkylcycloalkylaryl-, alkylarylcycloalkyl-, arylcycloalkylalkyl-, arylalkylcycloalkyl-, cycloalkylalkylaryl-, and cycloalkylarylalkyl-radicals, which are:
unsubstituted or substituted by at least one radical (a1211),
comprising at least one at least divalent, heteroatom (a1212) or free from heteroatoms, and
comprising at least one at least divalent, linking functional group (a1213) or free from such groups,
the hyphen symbolizing in each case the covalent bond between a carbon atom of a radical and the nitrogen atom of the carbamate group.

19. A process for preparing a copolymer (A) comprising lateral, primary, or secondary carbamate groups (a12), or a combination thereof, and groups (a31) which can be activated with actinic radiation, which comprises
I. in a first process step copolymerizing
(a1) at least one monomer comprising
(a11) at least one group of the general formula I:
CH₂═C(R)C(O)—O— (I),
wherein the variable R is a hydrogen atom, a halogen atom, a nitrile group or an alkyl group having 1 to 10 carbon atoms, and
(a12) at least one primary carbamate group, secondary carbamate group, or a combination thereof,
and
(a2) at least one monomer comprising
(a21) at least one free-radically or ionically polymerizable, olefinically unsaturated double bond and
(a22) at least one reactive functional group which is not reactive with the carbamate groups (a12) and is not polymerizable with the double bond (a21),
to give a copolymer (a1/a2), and
II. in a further process step, reacting the copolymer (a1/a2) with
(a3) at least one compound comprising
(a31) at least one group which can be activated with actinic radiation and
(a32) at least one reactive functional group complementary to the reactive functional group (a22),
to give the copolymer (A).

20. The copolymer (A) as claimed in claim 1, as materials curable thermally and with actinic radiation.

21. The copolymer (A) as claimed in claim 20, wherein the materials curable thermally and with actinic radiation are dual-cure coating materials.

22. The copolymer (A) as claimed in claim 21, wherein the dual-cure coating materials are dual-cure clearcoat materials.

23. The copolymer (A) as claimed in claim 21, wherein the dual-cure materials are used to produce dual-cure thermoset materials.
